(19) United States
(12) Patent Application Publication
(10) Pub. No.: US 2023/0419350 A1
(43) Pub. Date: Dec. 28, 2023

(54) SYSTEMS AND METHODS FOR FORECASTING IMMEDIATE-TERM PRICE MOVEMENT USING AN ARTIFICIAL NEURAL NETWORK

(71) Applicant: Jaiwen Song, Chantilly, VA (US)

(72) Inventor: Jaiwen Song, Chantilly, VA (US)

(21) Appl. No.: 18/215,135

(22) Filed: Jun. 27, 2023

Related U.S. Application Data
(60) Provisional application No. 63/355,762, filed on Jun. 27, 2022.

(51) Int. Cl. G06Q 30/0201; G06Q 40/06

(52) U.S. Cl. CPC G06Q 30/0206; G06Q 40/06

(57) ABSTRACT

Software-based systems and methods are provided to perform short-term forecasts on price movements of financial instruments, such as public company stocks, commodities, cryptocurrencies, and others. A financial instrument's historical price data is used to train a group of artificial neural networks (ANN) to recognize the price movements of the target security. The learned ANN models are saved and as the system receives new price data, it retrieves the learned models and generates forecast results. For example, forecasts of price movements for two to 10 days ahead can be produced.

This application claims the benefit of U.S. Provisional Patent Application Ser. No. 63/355,762, filed Jun. 27, 2022, the entire disclosure of which is incorporated herein by reference.

### TECHNICAL FIELD

The present invention relates generally to electronic systems and methods for collecting market data, forecasting price movements in markets for financial instruments using a neural network, and distributing forecasts using a digital communications network.

### BACKGROUND ART

The adoption of artificial intelligence (AI) has gained pace in recent years because of many capabilities being readily available, including affordable data storage capacities, robust sensors with stable connectivity, and sufficient computing power. Artificial neural networks (ANN) are one of the AI methods that has seen increased popularity in different industries, especially in financial markets. Many market participants seek to exploit the predictive powers of ANN to gain an information edge and secure bigger profits in their trading operations. Depending on the market participants' strategies and investment horizons ANN users often focus their forecast efforts on different time horizons; from less than 5 years, short term, to more than 10 or 15 years, intermediate or long term respectively.

While ANN offers immense predictive capability, there are numerous technical hurdles preventing its wide-scale adoption at public consumer level. For example, the mathematical fundamentals on which the ANN method is based, software development skills, and obtaining sufficient computing power are potential obstacles. Due to these and other obstacles, applications of ANN in financial markets have chiefly been limited to institutional users, such as hedge funds, investment banks, and proprietary trading firms.

The inventor has determined that there is a need for a consumer-oriented ANN-based software tool that allows individual investors to harness the benefits AI methods can bring to investment analysis.

### BRIEF SUMMARY OF THE DISCLOSURE

In disclosed embodiments, software-based systems and methods are implemented to provide short-term forecasts on price movements of financial instruments, such as public company stocks, commodities, cryptocurrencies, and others. Example embodiments use a specific instrument's historical price data and trains a group of artificial neural networks (ANN) to recognize the price movements of the target security. The learned ANN models are stored, and when the system receives new price data, it retrieves the learned models and generates forecast results upon request. The system is able to use historical price data for different periods, such as daily, weekly, or monthly.

The forecast horizon can be customized to the user's needs. In an example embodiment the process disclosed herein can generate forecast results from two to 10 time periods ahead. If daily price movement data is used for prediction, the process will forecast from two to 10 days ahead based on current price data.

### BRIEF DESCRIPTION OF THE DRAWINGS

The accompanying drawings, which are incorporated herein and form a part of the specification, illustrate various exemplary embodiments of the present invention and, together with the description, further serve to explain various principles and to enable a person skilled in the pertinent art to make and use the invention.

FIG. 1 is a data flow diagram for an example embodiment of the Encoder-Decoder LSTM network architecture and work flow. In this example, both encoder and decoder blocks use LSTM neurons followed by a block of fully connected neurons.

FIG. 2 is a flow diagram for an embodiment implementing a 1-D convolutional LSTM network architecture and work flow. The network in this example comprises a 1-D convolutional block, LSTM block and fully connected block.

FIG. 3 is a flow diagram for a 2-D convolutional LSTM network architecture and work flow embodiment. The network in this example comprises a 2-D convolutional block, LSTM block and fully connected block.

FIG. 4 is a basic work flow diagram of an example embodiment of a software tool as disclosed herein. In this example, trainer and predictor components share some common processes.

FIG. 5 is a flow diagram showing work flow of an example embodiment of a trainer tool. The trainer in this embodiment is responsible for producing learned neural network models.

FIG. 6 is a flow diagram of an example embodiment of a predictor tool. The predictor in this example uses learned neural network models to calculate price movement forecast and feeds the result data to the user interface.

FIG. 7 is a diagram of data organization in an example embodiment for neural network training.

FIG. 8 is a diagram illustrating the use of data in calculating forecast results in an example embodiment.

FIG. 9 is a block schematic diagram showing an example embodiment of system architecture appropriate for training ANN models in a desktop workstation environment.

FIG. 10 is a block schematic diagram of an example embodiment of predictor system operation in a desktop workstation environment.

FIG. 11 is a block schematic diagram of an example embodiment implementing the trainer operation in a cloud computing environment.

FIG. 12 is a block schematic diagram showing an example of predictor operation in a cloud computing environment.

### BEST MODE FOR CARRYING OUT THE INVENTION

The present invention will be described in terms of one or more examples, with reference to the accompanying drawings.

The present invention will also be explained in terms of exemplary embodiments. This specification discloses one or more embodiments that incorporate the features of this invention. The disclosure herein will provide examples of embodiments, including examples from which those skilled in the art will appreciate various novel approaches and features developed by the inventors. These various novel approaches and features, as they may appear herein, may be used individually, or in combination with each other as desired.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, persons skilled in the art may implement such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors, typically distributed in a network. A machine-readable medium may include any mechanism for storing or transmitting information in a form readable by a machine (e.g. a computing device). For example, a machine-readable medium may include read only memory (ROM); random access memory (RAM); hardware memory in handheld computers, tablets, smart phones, and other portable devices; disk storage media; optical storage media; flash memory devices; electrical, optical, acoustical, or other forms of propagated signals (e.g. carrier waves, infrared signals, digital signals, analog signals, etc.), internet cloud storage, and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

An example embodiment of the present invention provides improved electronic systems, network arrangements, and improved processing methods for collecting market data, forecasting price movements in markets for financial instruments using a neural network, and distributing these forecasts.

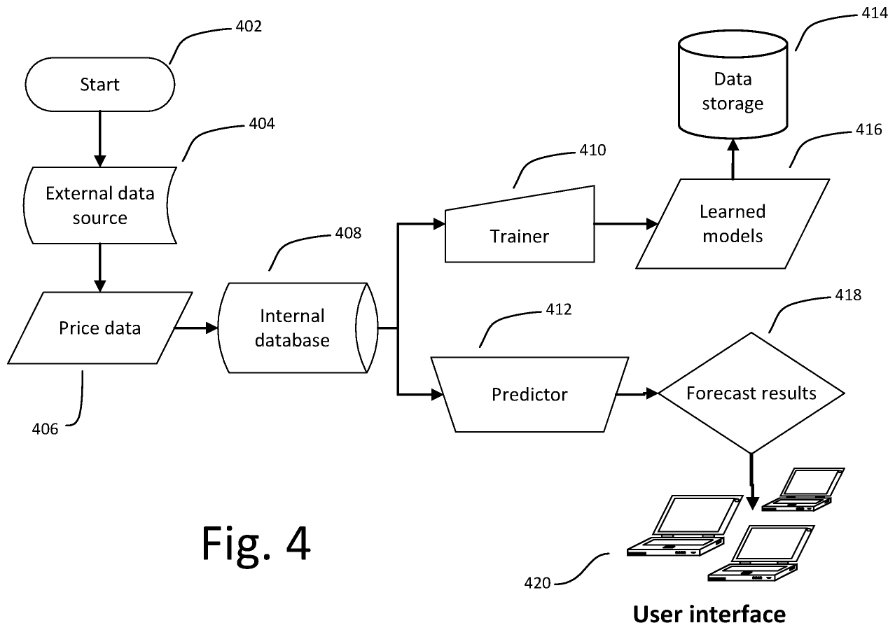

The exemplary software system for forecasting comprises a trainer and a predictor. FIG. 4 illustrates, at a high level, an example process for training ANN models, generating predictions based on those models, and taking actions in response. The process starts at step 402. Initially an external data source is accessed in step 404 to retrieve price and other relevant data in step 406. That data is stored in an internal database in step 408 so that it is available for further analysis. In an embodiment, the system's internal database is a relational database. The database service is supported in an example embodiment by the MySQL engine. The database is used in this example to store (among other data) daily price data for publicly traded companies of interest.

Records of the predictions made by the system and the ANN models employed are also preferably stored in database 408. In step 410, a trainer processes the available data and in step 416 generates learned ANN models, in a manner that will be described in more detail with reference to the other drawing figures. In step 414 the learned models are stored for subsequent use. In step 412, a predictor uses the ANN models previously generated by the trainer. In the present example in step 418 the predictor generates predictions of price changes in a financial instrument for which the operator wants to predict market activity. In step 420, the predictions are reported to a user interface so that the user can act on the predictions as desired. In addition to reporting the predictions to a user, the system can take automatic steps, including initiating communications via a computer network such as the internet. In one example, these communications comprise connecting directly to one or more remote computing devices and transmitting information to inform the recipient of the generated predictions. For example, parties may subscribe to receive predictions from the system and the system may then be configured to automatically transmit selected predictions that are deemed to be of interest to the subscriber, through a network connection to the subscriber's computing device. The network connection used may be a direct data transmission link to software in the subscriber's device. The user interface may also comprise a web server that allows subscribers to log in via the internet or another network, and view pages generated by the system that are updated in real time as new predictions are generated.

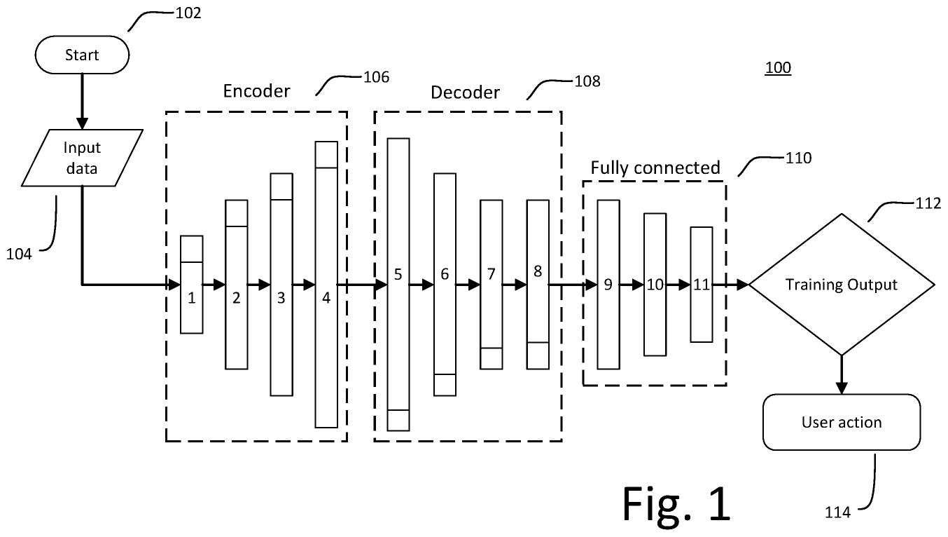

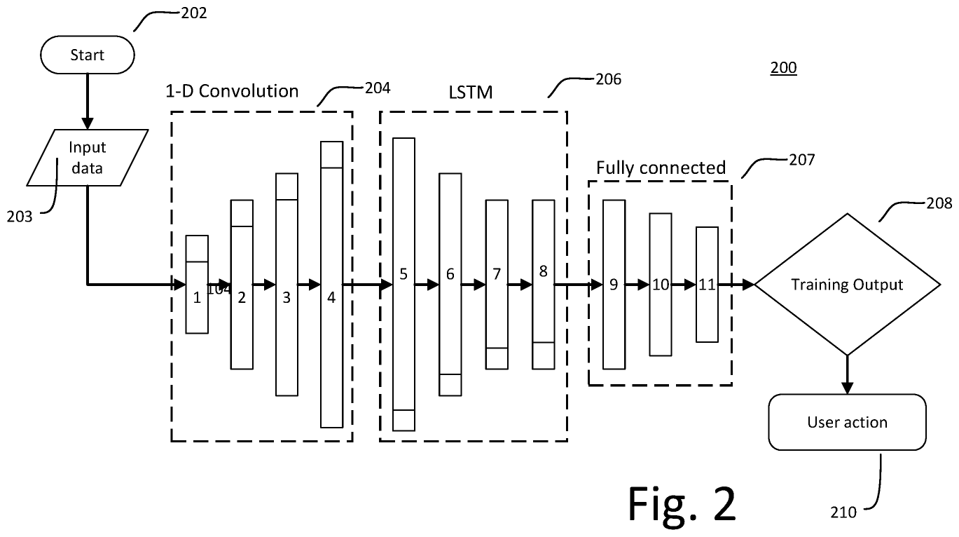

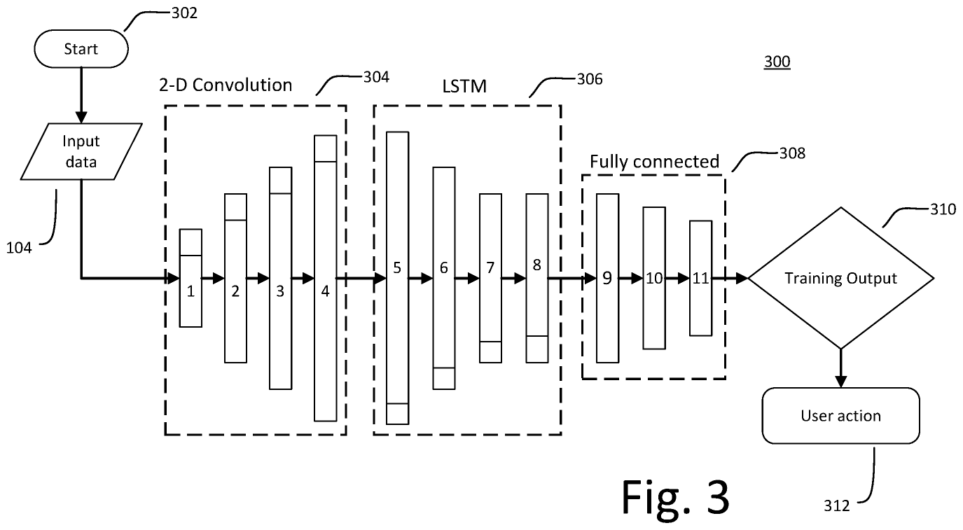

In a preferred embodiment, the forecast tool incorporates long short-term memory (LSTM) neural network architecture. Optionally, in the example embodiments herein, three types of LSTM architecture can be used in the software system: Encoder-Decoder LSTM (illustrated in FIG. 1), One-dimensional (1-D) Convolutional LSTM (illustrated in FIG. 2), and Two-dimensional (2-D) Convolutional LSTM (illustrated in FIG. 3). The software system preferably uses various purposely developed tools to take up common responsibilities; in an example embodiment, these may include an internal database, a data processor; and the trainer and predictor.

The prediction processes provided herein are preferably configured to apply multiple ANN models to produce forecast results. The trainer components described herein are responsible for producing learned ANN models. FIGS. 1 through 3 provide a simplified illustration of example embodiments of the three neural network architectures that are the basis of the ANN models used in the example embodiment. While the three network types share similarity in architecture, one key difference is the first block, comprising layers of the network that receives the input data.

Referring first to FIG. 1, a high-level flow diagram for generating predictions using an encoder-decoder LSTM starts at step 102 and obtains input data for predictions in step 104. The model then processes the data through encoder step 106, decoder step 108, and fully connected step 110 to product output at step 112. The output may be combined with the output of other models and the results may prompt a response from a user monitoring the predictions in step 114. In addition, actions may be taken automatically in response to predictive output, including generating network communications interactions as further described herein.

In this example encoder-decoder LSTM network, the first block contains 4 layers of neurons. Each layer contains different numbers of LSTM neurons. This block is the LSTM encoder. The encoder block is then followed by the decoder block, which also consists of 4 layers of LSTM neurons. The number of LSTM neurons is increased in each layer of the encoder block. In an example embodiment the neuron numbers in layer 1, 2, 3, 4 are 64, 128, 256, 512 respectively. Conversely the decoder block contains layers with decreasing numbers of neurons. In an exemplary embodiment, the neuron numbers in layers 5, 6, 7, 8 are 512, 256, 128, and 128 respectively. Data produced from the decoder block is entered into the block of fully connected layers. In an example embodiment, three fully connected layers of different neurons are used, where the number of neurons in layers 9, 10, 11 are 128, 64, and 32 respectively. Finally, in an embodiment, all the computations of the neural network layers are consolidated into a single neuron as the output. The output neuron can be configured to produce forecast results of any time horizon on any frequency period. As an example, the neural network is configured to forecast on a daily frequency and a forecast horizon of 5; that is, forecasting each day's close price for the next 5 days.

FIG. 2 is a high-level flow diagram for generating predictions using a 1-D Convolution LSTM. Process 200 starts at step 202 and first obtains input data for predictions in step 203. The model then processes the data through 1-D Convolution step 204, LSTM step 206, and fully connected step 207 to produce output at step 208. In step 210, actions may be taken by a user or may be taken automatically in response to single, cumulative, or combined predictions, depending on the objective of the particular prediction function, including generating network communications interactions as further described here.

FIG. 3 is a high-level flow diagram for generating predictions using a 2-D Convolution LSTM. This process starts at step 302 and obtains input data for predictions in step 104. The model then processes the data through 2-D Convolution step 304, LSTM step 306, and fully connected step 308 to produce output at step 310. In step 312, various actions may be taken by a user or are in some cases taken automatically in response to single, cumulative, or combined predictions, depending on the objective of the particular prediction function, including (in some embodiments) generating network communications interactions as further described herein.

The convolutional LSTM networks, both one-dimensional (1D) as shown in FIG. 2 and two-dimensional (2D) as shown in FIG. 3, use a similar architecture to that of the example given of an encoder-decoder LSTM network. In this embodiment, instead of using LSTM layers in the first block of the neural network, a convolutional network uses multiple layers of convolution filters, either 1D or 2D filters, and pooling; hence a convolution block. In this example embodiment, the convolution block uses multiple sets of convolution filter layers. Each set contains two convolution layers of identical number of filters followed by a pooling layer. In the example, the convolution block contains four sets of convolution filters; the number of filters in sets 1, 2, 3, 4 are 64, 128, 256, and 512 respectively. Because there are multiple layers in a convolution set, the convolution block in this example contains 12 layers of filters and pooling. Following the convolution block in this embodiment are the LSTM block and fully connected block, similar to the encoder-decoder LSTM network. In the example, the number of neurons in layers 5, 6, 7, 8 of the LSTM decoder block are 512, 256, 128, and 128 respectively. The number of neurons in layers 9, 10, 11 of the fully connected block are 128, 64, and 32 respectively in the example embodiment.

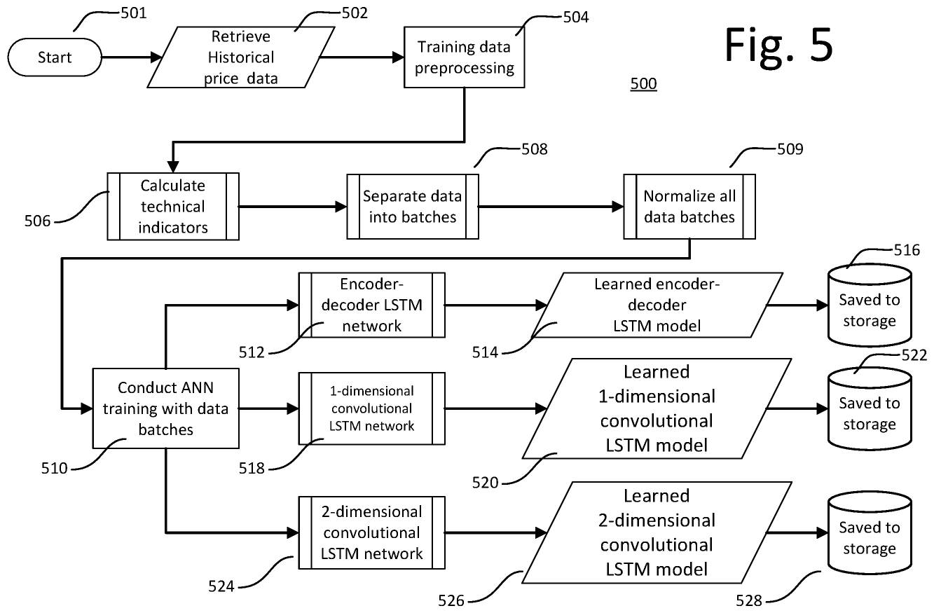

FIG. 5 is a more detailed flowchart showing an example process for generating ANN models that can be used to predict financial market activity. The process starts at step 501. In step 502 historical price action data is retrieved from the database. The data is preprocessed in step 504, and technical indicators are calculated in step 506 as described herein. The data is separated into batches in step 508 and normalized in step 509. ANN training is then conducted for each data batch in step 510. The process then generates three different LSTM models in parallel. The first parallel path starts at step 512 for generating an encoder-decoder model. In step 514 an ANN model is learned and in step 516 it is saved to storage. The second parallel path starts at step 518 for generating a 1-dimensional convolutional model. In step 520 an ANN model is learned and in step 522 it is saved to storage. Similarly, the third parallel path starts at step 524 for generating a 2-dimensional convolutional model. In step 526 an ANN model is learned and in step 528 it is saved to storage.

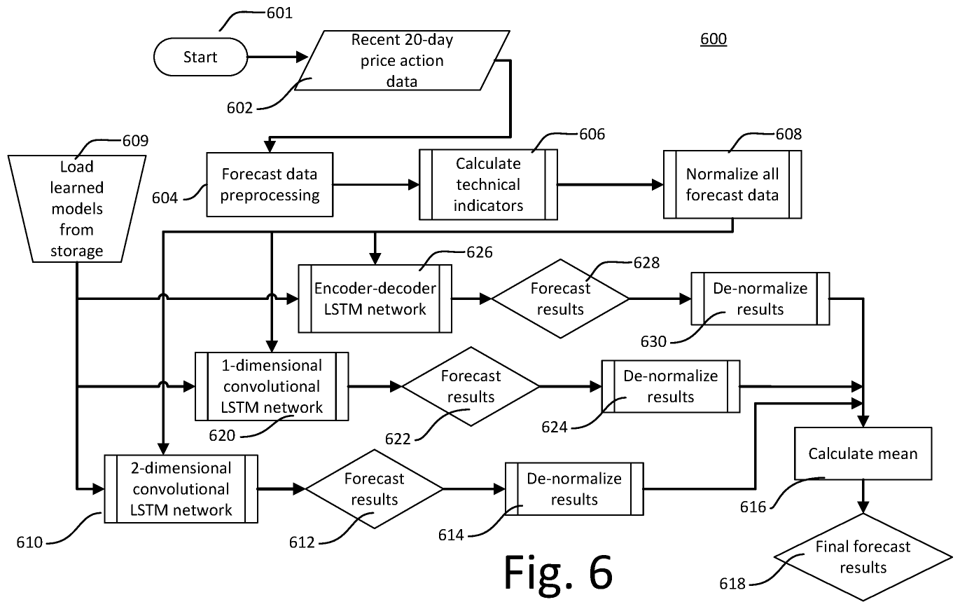

FIG. 6 shows a process for generating a mean forecast from a plurality of forecast results. Process 600 starts with step 601 and then recent 200-day price action data is retrieved in step 602. The data is preprocessed in step 604, technical indicators are calculated in step 606, and the data is normalized in step 608. While these steps are performed, learned models of different types are being loaded from storage in step 609. The data is submitted to an encoder-decoder network in step 626, forecast results are generated in step 628, and the results are denormalized in step 630. Meanwhile, the data is also submitted to a 1-dimensional convolutional network in step 620. Forecast result from that network are obtained in step 622 and the results are de-normalized in step 624. The data is also submitted in parallel to a 2-dimensional convolutional network in step 610. Forecast result from that network are obtained in step 612 and the results are de-normalized in step 614.

A mean value is calculated in step 616 from the de-normalized results of the three models, as produced in steps 614, 624, and 630. The final forecast results are provided in step 618 for human review or to initiate automatic activity, as desired.

To avoid confusion FIG. 6 shows the averaging of forecast results from three models. However, as discussed herein, preferably a larger number of models, such as 30 ANN models, are used to calculate the final forecast. The additional results are calculated in the same manner shown in FIG. 6 for the three example types of ANN models, and averaged with the other forecast results in step 616.

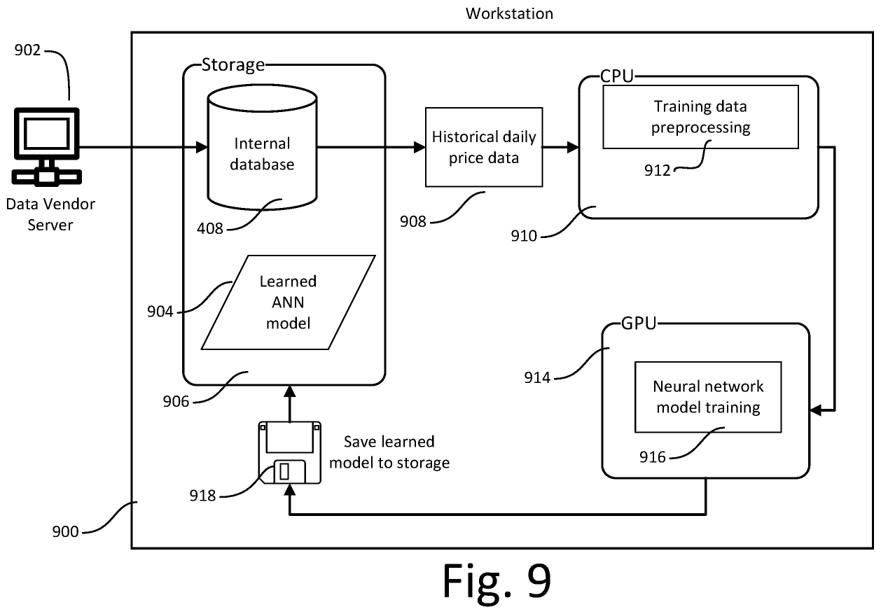

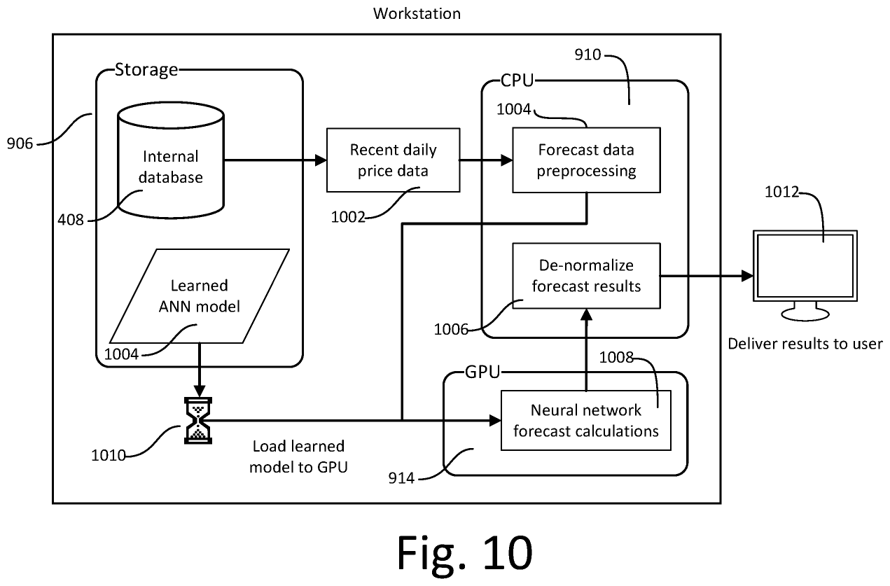

FIGS. 9 and 10 are block schematic diagrams of an embodiment of the present system that operates on a workstation 900. Although some components of workstation 900 are common to both the training and prediction functions, FIG. 9 highlights components that are involved in training, and FIG. 10 highlights components of the workstation that are involved in predictive operations.

Referring first to FIG. 9, a data vendor server 902 is operable connected (such as via an internet or other network connection) to provide data to workstation 900. Data may be provided as a push operation without a specific request from the workstation 900, or may be transmitted by the server 902 in response to a request signal or other handshaking communications transmitted between server 902 and workstation 900. Data from server 902 is transmitted to storage 906, which may be a solid-state disk or other available storage device compatible with workstation 900. Storage 906 comprises internal database 408 for receiving the data from server 902 and storage space 904 for storing learned ANN models for ongoing use. Storage 906 is connected to CPU 910 which, for training purposes, is provided with training data preprocessing machine code 912. CPU 910 receives historical process data 908 from database 408 and processes it as described in more detail below. CPU 910 is connected to GPU 914 which is provided with neural network model training machine code 916. CPU 912 and GPU 914 work together to generate new predictive models, and new models thus generated are saved in storage 906 or may be stored in a different storage location 918.

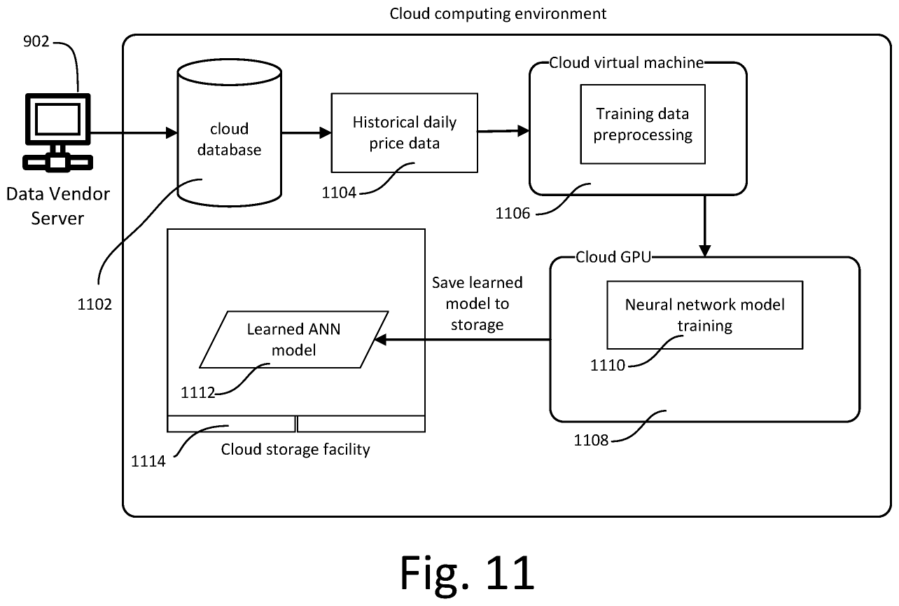

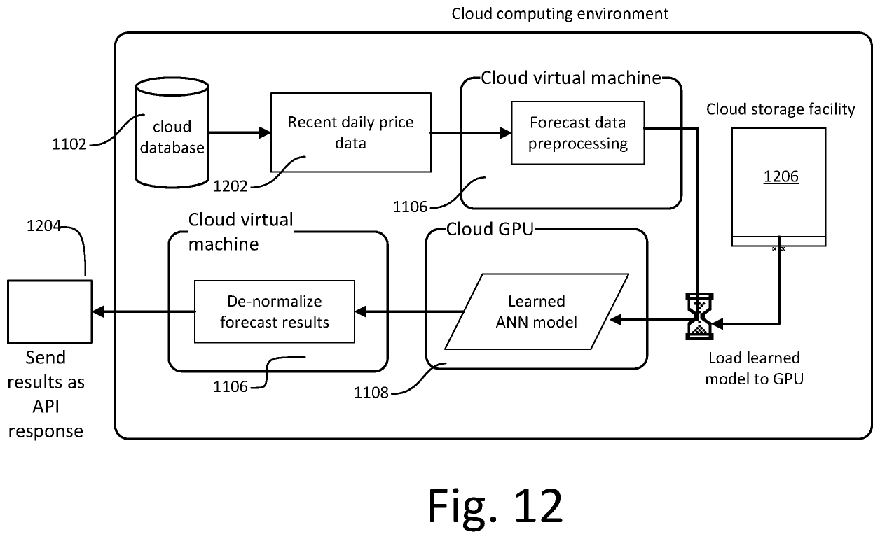

In the example embodiments herein, the GPU acts as a second, general-purpose parallel processing device rather than to produce graphics output. One example of a GPU that can be used for this purpose is an NVIDEA GTX 1050 Ti, which has over 750 processor cores that can perform calculations in parallel. However, more powerful processors that have 2000 or more processor cores will produce faster results. Those skilled in the art will also appreciate that while GPUs are commercially available on a widespread basis at reasonable cost, a GPU is merely an example of the category of hardware used in the example embodiments. Other types of parallel processing computing devices that are not designed to be graphics cards can also perform the functions described herein for the second, parallel processing system. In addition, as will be seen with reference to FIGS. 11 and 12, crowdsourced processing power and virtual parallel processors provided by cloud computing services can also be used for this purpose.

In a preferred embodiment, workstation 900 automatically accesses one or more predetermined data vendor servers 902 at the end of each trading day, to download the day's price data via an internet connection. This data retrieval is accomplished by electronically communicating with data vendor server 902 using an application programming interface (API) provided by the vendor. The price data obtained preferably includes the numerical values of opening price, highest price, lowest price, closing price, volume, and the corresponding adjusted data, i.e., adjusted open, adjusted high, adjusted low, adjusted close, adjusted volume, of a given trading day. The public company's valuation data is also obtained as an input to the predictions generated by the system. This information may comprise (for example) market capitalization, enterprise value, price-to-earnings ratio, and price-to-book ratio. Database 408 can also be expanded to store prices of other financial instruments, including commodities, foreign currency exchange rates, cryptocurrencies, and others. It can also be expanded to store price data of different time intervals, for example, prices at end of one hour or even one minute if such data is available.

Training data preprocessing code 912 preferably provides functionality to support various operational needs in the training process. Among other functions, this code preferably calculates technical trading indicators as part of the neural network input data. A preferred example embodiment generates three technical indicators: 5-day moving average (MA5), 10-day moving average (MA10), and momentum.

$$MA 5 = \frac{1}{5} {\sum }_{i = 1}^{5} {C}_{t - i + 1}$$

$$MA 10 = \frac{1}{10} {\sum }_{i = 1}^{10} {C}_{t = i + 1}$$

$$Momentum = {C}_{t} - {C}_{10}$$

Where Cₜ is the value of the given date's adjusted closing price, Cₜ₋₁ is the prior date's adjusted closing price, and C₁₀ is the adjusted closing price of the 10th business day prior to the given date.

In addition to calculating technical indicators, in the example embodiment, training data preprocessing code 912 is responsible for packaging the numerical data into usable format for a neural network. For training, the data processor retrieves all available daily data of a particular company, computes the technical indicators described above based on the adjusted close prices, then combines the indicator values into the data set. Then the data processor separates the entire data set into data batches. Each data batch preferably contains an approximately equal number of data points. In an embodiment, the data points in a batch may span a time period of three months. After the data batches are formed, each batch is individually normalized; Min-Max normalization is used:

$${V}^{′} = \frac{V - min}{max - min}$$

Where V is the original value of a data feature in a data point, e.g. adjusted opening price, adjusted closing price, MA5, etc. V′ is the normalized value of the data feature, and min and max are the minimum and maximum values of the corresponding data feature during the period in a data batch. After normalization is completed, the data batches can be used by the trainer to conduct neural network training using training code 916 operating in GPU 914 as described above.

To simplify the drawing figures of the example embodiment, a single data vendor server 902 is shown in FIG. 9. However, those skilled in the art will appreciate that workstation 900 may receive data of varying types from one source or a plurality of sources that can all be connected to provide relevant information to workstation 900.

FIG. 10 highlights the hardware components and the software/firmware code sections that are used to generate predictions in workstation 900. When the predictor is run as a desktop application, a company's price data is preferably loaded from a database on the computer's hard drive to RAM. On the computer's CPU the necessary data preprocessing procedures are preferably conducted so the input data used in prediction is in a consistent format as that used in training. In an example embodiment, the learned ANN models are loaded into the computer's GPU from the hard drive; and the input data is fed to the ANN models for calculation. The forecast results from different ANN models are then de-normalized on the CPU, restoring the result value range to the range of the company's stock prices; then an average is calculated of the results. The average forecast value is provided on the computer's display device, or may be transmitted to a human user via the internet or other network to be reviewed and acted upon by the user.

Referring in more detail to FIG. 10, storage 906, CPU 910, and GPU 914 may be the same physical hardware described in FIG. 9 or may have similar characteristics. Daily price data 1002 is transmitted from internal database 408 to CPU 910, which for prediction generation purposes is provided with software/firmware code comprising forecast data preprocessing code 1004 and de-normalize forecast results code 1006. GPU loads stored ANN models from storage location 1004 and preprocessed forecast data resulting from the execution of code 1004 in CPU 910 on data 1002 (and optionally, other data). The GPU then processes the data using the ANN models by executing neural network forecast calculation code 1008. The GPU output is transmitted to the CPU for processing by de-normalize forecast results code 1006, and the resulting predictions are acted upon, either automatically or by sending them to a user-perceptible device 1012.

The data processor tool (forecast data preprocessing code 1004) preferably retrieves the most recent 20 days of daily price data then computes the technical indicators and normalization to the 20-day daily data. When the predictor completes the forecast calculation, de-normalize forecast results code 1008 is executed to reverse the normalization procedure on the results, thus providing forecast results of the upcoming adjusted closing prices.

Although components of workstation 900 are shown in FIGS. 9 and 10 as single devices, such as a single CPU and GPU, a plurality of any component of the workstation may be provided to increase computing power. The physical location of devices in the same box or in separate boxes can provide useful operating results. Additional CPUs and GPUs, for example, may be located in a single machine or a network of machines may be connected together to apply parallel processing power to the generation of models and predictions.

FIGS. 11 and 12 are block schematic diagrams of an embodiment of the present system that operates in a cloud computing environment. Although some components of the cloud are common to both the training and prediction functions, FIG. 11 highlights components that are involved in training, and FIG. 12 highlights components of the cloud and software/firmware code sections that are involved in predictive operations.

Referring to FIG. 11, when the trainer software is executed in a cloud computing environment, hardware components of a desktop computer are replaced by cloud services offered by a cloud computing provider. The trainer's cloud environment workflow is preferably generally like the workflow in a desktop computer environment as described with reference to FIG. 9. Data preprocessing and ANN model training in cloud computing embodiments may be executed on a single virtual machine (VM) or on multiple VMs. In a preferred embodiment, the data preprocessing procedures are executed on a VM, and the ANN training algorithms are executed on a GPU-equipped VM. The learned ANN models are preferably saved in a separate storage facility, separate from the database. FIG. 11 provides an example of this type of cloud computing structure including a cloud database 1102, cloud virtual machine 1106, cloud GPU 1108, and cloud storage facility 1114. In the generation of ANN models using the cloud environment of FIG. 11, data from data vendor server(s) 902 is stored in the cloud database 1102 and daily price data 1104 is provided to cloud virtual machine 1106. Cloud virtual machine 1106 executes training data preprocessing software or firmware that performs the same functions described above with reference to the workstation embodiment of FIG. 9. Cloud GPU 1108 then executes neural network model training code (performing functions similar to those performed by the hardware GPU in FIG. 9). Learned ANN models 1112 generated by cloud GPU 1108 are saved to a cloud storage facility 1114 from which they can be retrieved for generating predictions.

In FIG. 12, predictions are generated using a cloud computing environment. In this embodiment, the predictor software is configured to run in a cloud environment. If the predictor is intended to provide daily price movements predictions, it is preferably run every weekday after financial markets are closed.

In embodiments where the predictor software is run in a cloud environment a similar work flow to that in the desktop environment is preferably adopted. When running as a cloud predictor, the software is preferably used to answer a request for data received from a remote user via the internet or other network. In an example embodiment, companies' price data is stored separately from the learned ANN models. A VM loads a company's price data to conduct data preprocessing to create input data. Preferably, the company's learned ANN models are loaded from a specified cloud storage facility to a GPU-equipped VM. The ANN models receive the input data and calculate the forecast results. The forecasts are then passed to a different VM for de-normalization and average calculation. In this example embodiment, the final result is sent in an acceptable format as part of a digitally transmitted response to an internet request that is received and acted upon by a user at a remote location.

Cloud virtual machine 1106 preferably executes code to take in daily price data 1202 and perform forecast data preprocessing functions similar to those performed by the workstation embodiment described with reference to FIG. 10. The preprocessed data is transmitted to cloud GPU 1108, which also receives stored ANN models from cloud storage facility 1206. Cloud GPU 1108 then applies the ANN models to the preprocessed data to generate predictions. The predictions are transmitted to cloud virtual machine 1106 (shown as the same machine that performed the preprocessing functions, although separate virtual machines may be used for selectively processing tasks that are to be performed by virtual machines). The virtual machine de-normalizes the forecast results, preferably using the process described with reference to FIG. 10 and transmits them via the internet or another network to a remote computing device 1204, as a response to an API request for one or more predictions.

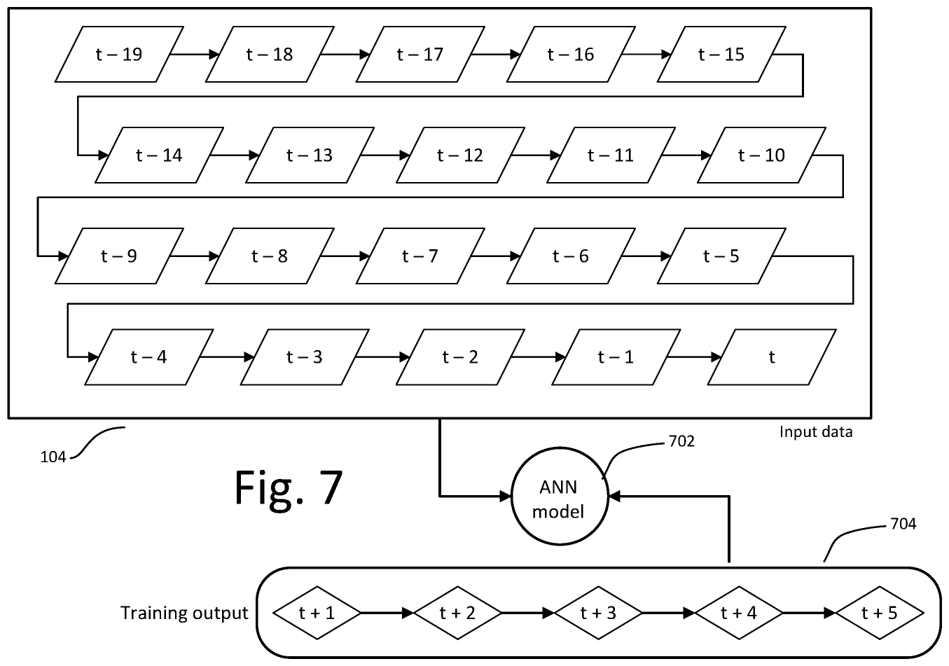

Referring now to FIG. 7, the trainer component of the software is responsible for conducting neural network training and saving the learned models once the training requirement is satisfied. In a preferred embodiment, the software downloads stock data with a daily frequency. At the end of each trading week, the trainer retrieves all available price data of at least one particular company stock. The data processor takes the price data and conducts the necessary preparation as previously described. In this example, the data processor calculates technical indicators, separates data into small batches, and individually normalizes each small batch. After the preparation is completed, the trainer preferably instantiates an ANN model, then feeds the data batches to the ANN model. Each data batch in the example implementation contains between 80 and 120 data points. Each data point contains information for the input to the ANN model and the expected output. In an example embodiment, the input consists of 20-day price data.

During neural network training all data batches are preferably fed to the ANN model. The data batches in training are preferably chronologically arranged, so the oldest points are first to be fed and the most recent data points are the last to be used. When all the data batches have been fed the ANN model is deemed to have completed 1 epoch of training. The process is then repeated a predetermined number of times. Preferably, the training requirement is 660 epochs although this can be varied based on testing and empirical results. Once the ANN model has completed the required training epochs, the model is considered trained and it is saved as a retrievable file on a storage medium. which may comprise a computer drive or cloud storage drive as shown in FIGS. 9 and 11 respectively.

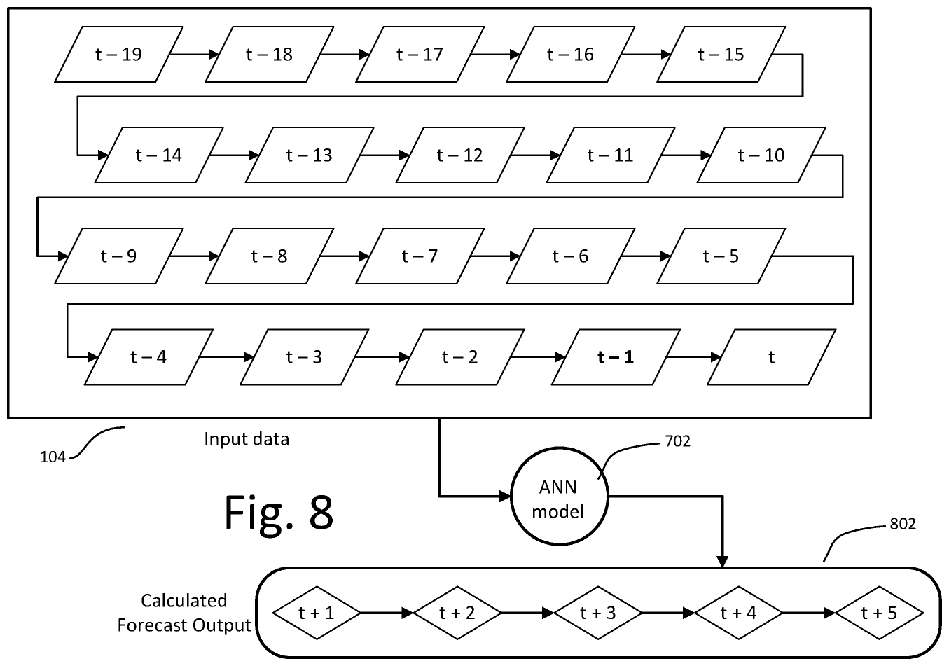

As shown in FIG. 8, on a trading day when predictions are to be generated, input data 104 consists of price data of the day along with data of previous 19 days (input data 104 in FIG. 8). The output in this example consists of 5-day price data 802. On the particular trading day, the output is a prediction of the next 5 trading days' adjusted close prices.

To create ANN models in this example embodiment, two computers with NVIDIA GPUs can be used to perform the training process described. Each computer creates three models at a time for each company. The speed of the process depends on the power of the computers and GPUs used. As an example, with a typical current-generation PC and GPU, six new models can be created for each company in a weekend training session. Previously generated ANN models can also be employed for prediction. In this example embodiment a total of 30 active models are maintained for each company, including newly and previously generated models. The number of models to keep and apply to predictive efforts can be varied depending on available storage capacity.

In the example where the trainer component creates three different ANN models at a time for a particular company, the models created may be encoder-decoder LSTM, 1D convolutional LSTM, and 2D convolutional LSTM models. Each type of ANN model is preferably trained with identical data of a particular company and required to complete the predetermined number of training epochs. When the trainer completes training one type of ANN model and saves the model to a file, it continues the process to the next type of ANN model. In this example, after all three ANN models of a particular company have been trained and saved, the current training process for the company is deemed completed. The trainer may then repeat the data preparation and training with a different company's data.

In an example embodiment, the predictor component of the software is responsible for loading the saved models and calculating forecast results. When the predictor is run a particular company's most recent price data is retrieved from the database. Preferably, in this embodiment, only the data of the most recent 20 days is retrieved. The data processor tool in this example conducts a preparation process like that performed with the trainer component to produce input data, including calculating technical indicators and normalizing the data.

After the data preparation, the predictor preferably loads the available learned ANN models to compute the forecast results for the particular company. As shown in FIG. 8, in this example data used in the predictor does not include output. In a preferred example, the predictor uses 30 ANN models for each company. In this example embodiment, the following process occurs: Each ANN model is individually loaded from the storage medium into memory. The input data is fed into an ANN model. The forecast result output is produced and stored in memory. Then a different ANN model of the same company is loaded and fed the input data; the forecast output is stored. The process is repeated in this example embodiment with all 30 ANN models. After all the available ANN models have computed forecasts, the results are averaged to produce the final forecast result for the particular company. The final forecast result is preferably saved to a file on a storage medium. The resulting file can be accessed by users, either from the company hard drive or web server.

Optionally, an accuracy evaluation step is added to the predictor process to improve the accuracy of the forecast results. In this optional embodiment, the system performs the additional step of evaluating the directional price movement results of each ANN model and selecting which models to use based on empirical results. Each ANN model's predictive performance is evaluated against recently observed data. Preferably, this evaluation is conducted by first calculating a directional accuracy score (DAS) for each ANN model. This score can be calculated over any desired period. In this example, a 5-day window is used for evaluation. The score is calculated after the markets close for a particular day. The variable “t” is defined as the most recent observed stock closing price (for example, today's closing price) for the financial instrument being evaluated. Then t−1, t−2, t−3, t−4, are the closing prices for the previous four days as follows:
t: today's closing price
t−1: 1-day prior closing price
t−2: 2-day prior closing price
t−3: 3-day prior closing price
t−4: 4-day prior closing price

When a five-day window is used as in this example, an ANN model's forecasted results corresponding to observed closing prices contains five prices, where “f” is the forecasted price for the fourth previous day, and f+1, f+2, f+3, and f+4, are the forecasted prices for the third previous day, the second previous day, the previous day, the most recent day, respectively.
f: 4-day prior forecasted price
f+1: 3-day prior forecasted price
f+2: 2-day prior forecasted price
f+3: 1-day prior forecasted price
f+4: most recent day forecasted price

In this example embodiment, the directional accuracy evaluation for the ANN is performed as follows. When t−3 is higher than t−4 and f+1 is also higher than f, the ANN model's forecast result is deemed to have predicted the direction of price movement correctly for that day and receives 1 point. If the movement direction prediction from the ANN was incorrect, i.e. t−3 is higher than t−4 and f+1 is lower than f, the result receives zero points. When t−3 is lower than t−4 and f+1 is also lower than f, the result also receives 1 point; otherwise, the result receives zero points.

The same process is repeated for all available observed closing prices within the time window selected for the directional accuracy evaluation, as follows:

If t−3 is higher than t−4 and f+1 is higher than f, or t−3 is lower than t−4 and f+1 is lower than f; the result receives 1 point, otherwise it receives 0 points for the t−4 to t−3 period.

If t−2 is higher than t−3 and f+2 is higher than f+1, or t−2 is lower than t−3 and f+2 is lower than f+1; the result receives 1 point, otherwise it receives 0 points.

If t−1 is higher than t−2 and f+3 is higher than f+2, or t−1 is lower than t−2 and f+3 is lower than f+2; the result receives 1 point, otherwise it receives 0 points.

If t is higher than t−1 and f+4 is higher than f+3, or t is lower than t−1 and f+4 is lower than f+3; the result receives 1 point, otherwise it receives 0 points.

After the step of awarding points to the ANN for accurate directional predictions has been completed, the points are totaled and divided by the total number of predictions to produce the DAS. In the example five-day window, the number of points received is divided by 4 because there are four day-to-day direction predictions that can be evaluated in the five-day period, and thus four possible points that could have been awarded for accurate directional prediction. The number of points divided by the possible number of points provides a percentage that is designated as the directional accuracy score (DAS) for the ANN model being evaluated.

If 30 learned ANN models are used to calculate a company's forecasted stock price, the DAS is calculated for each of the 30 ANN models to indicate its predictive performance in the most recent time window. If an ANN model's DAS is higher than a predetermined threshold set by the system operator, the ANN model's most recent forecast result is deemed qualified to be included in calculating the final forecast. If an ANN model's DAS is below the predetermined threshold, the ANN model's forecast result is discarded. In an example embodiment, the predetermined threshold DAS for including an ANN model in the forecast is 55%. This value can be adjusted by the system operator without undue experimentation based on empirical predictive results generated by the system. After all ANN models have computed forecast results, the results from ANN models with satisfactory DAS are then averaged to produce the final forecast result for a particular company. Thus, the quality evaluation steps disclosed herein (such as application of a DAS calculation and threshold for including and excluding ANN models) can be used to improve the prediction accuracy of the system.

The software system can be operated in a stand-alone desktop computer, a distributed cloud computing environment, or in other computing arrangements that will be apparent to those skilled in the art. When operated as a desktop software application, different components of a computer are used for different processes of the software. In an embodiment of the desktop application, publicly traded companies' stock price data is downloaded from a data vendor using an internet connection. The downloaded data is written to a relational database stored on the computer's hard drive. This data retrieval process preferably happens every weekday after financial markets are closed. When a user triggers the trainer, the training process is run. A company's price data is first loaded from the database onto random access memory (RAM) and passed to the data processor tool on the central processing unit (CPU) to conduct preprocessing, including organizing input and output data, organizing data batches, and normalization of each data batch. In this example embodiment, after preprocessing is completed, ANN models are instantiated and training is commenced. ANN training preferably employs a discrete graphic processing unit (GPU) in desktop embodiments, which is separate from the CPU. During training the ANN model's training algorithm is preferably executed on the GPU because a large number of computing cores can substantially speed up calculations and reduce the time used to complete the training. When the ANN model's training is completed, the model's data is preferably written to a file and saved to the hard drive or other data storage. The saved ANN model created in this manner has been trained to produce an accurate forecast; additional trainings for other companies' models can then be commenced.

In some embodiments, the forecast tool uses a group of artificial neural networks to provide immediate-term forecasts on financial assets' price movements. The primary purpose and benefits of the immediate-term information is that it allows market participants to take necessary actions based on the forecast results to achieve investment objectives. In example embodiments disclosed above, the methodology herein is used to forecast public company stock price movement one week in advance, or five trading days; it is also possible to apply the same methodology to predict price movements of the same or other financial assets, over a time period of the user's choice.

Although illustrative embodiments have been described herein in detail, it should be noted and understood that the descriptions and drawings have been provided for purposes of illustration only and that other variations both in form and detail can be added thereto without departing from the spirit and scope of the invention. The terms and expressions in this disclosure have been used as terms of description and not terms of limitation. Thus, the breadth and scope of the present invention should not be limited by any of the above-described exemplary embodiments but should be defined only in accordance with the claims and their equivalents. The terms and expressions herein should not be interpreted to exclude any equivalents of features shown and described, or portions thereof.

I claim:

1. An automatic system for predicting price changes in a financial instrument, comprising:
a. A computer comprising a central processing unit; an electronic data storage device operably connected to said central processing unit; and a mechanism for receiving historical price data for said financial instrument from an external source and storing it in said data storage device;
b. A second processing unit operably connected to said computer and having at least 750 processor cores operating in parallel to perform calculations;
c. Preprocessing program code operating in said computer that processes said historical price data and calculates one or more predetermined technical indicators, then provides a plurality of data batches including at least said processed historical price data and said technical indicators to said second processing unit;
d. Trainer program code operating in said second processing unit that performs artificial neural network training to generate at least three types of neural network learned models from said data batch, said three learned model types including an encoder-decoder long short-term memory network model, a 1-dimensional convolutional long short-term memory network model, and a 2-dimensional convolutional long short-term memory network model;
e. means for storing each of said three types of learned models for subsequent predictive use;
f. Predictor program code operating in said second processing unit to retrieve a plurality of stored learned models, provide at least one of said data batches to each of said plurality of learned models, obtain the resulting output of each said learned model, and calculate a forecasted market price for said financial instrument based on the combined output of said plurality of learned models; and
g. Delivering said forecasted market price in a visible medium to at least one user.

2. The system of claim 1 wherein said mechanism for receiving historical price data comprises a communications network link to a data vendor server.

3. The system of claim 1 wherein said second processing unit is a computer graphics card.

4. The system of claim 1 wherein said three artificial neural network model types are generated in parallel by the second processing unit.

5. The system of claim 1 wherein said historical price data comprises price action data for the financial instrument for at least 20 consecutive business days.

6. The system of claim 1 wherein said second processor has more than 2000 processor cores operating in parallel.

7. The system of claim 1 wherein said predictor program code calculates a forecasted market price for said financial instrument based on an average of predictions of said learned models.

8. The system of claim 1 further comprising:
a. A subscription server; and
b. Program code that electronically transmits said forecasted market prices to said subscription server as they are calculated;
wherein said subscription server is connected to the internet and executes program code that stores forecasted market prices produced by the system and provides controlled account access via the internet to computer systems operated by a plurality of subscribers to enable said subscribers to electronically retrieve said forecasted market prices.

9. The system of claim 1 further comprising accuracy evaluation program code that is executed in at least one of the computer and the second processor to calculate recent accuracy of each said learned model in predicting whether the market price of said financial instrument would increase or decrease from day-to-day, and to selectively omit from the calculation of said forecasted market prices the results of any learned models that have not correctly predicted day-to-day increase or decrease in price for at least a predetermined percentage of recent predictions.

10. An automated method for predicting price changes in a financial instrument, comprising the steps of:
a. Providing a computer that comprises a central processing unit and an electronic data storage device operably connected to said central processing unit;
b. Receiving historical price data for said financial instrument from an external source and storing it in said data storage device;
c. Providing a second processing unit operably connected to said computer and having at least 750 processor cores operating in parallel to perform calculations;
d. Executing program code in said computer to process said historical price data and calculate one or more predetermined technical indicators;
e. Electronically transmitting a plurality of data batches including at least said processed historical price data and said technical indicators to said second processing unit;
f. Executing trainer program code in said second processing unit to train a plurality of artificial neural networks using said data batch, including at least three types of neural network learned models, said three learned model types including an encoder-decoder long short-term memory network model, a 1-dimensional convolutional long short-term memory network model, and a 2-dimensional convolutional long short-term memory network model;
g. Storing each of said three types of learned models for subsequent predictive use;
h. Executing predictor program code in said second processing unit to retrieve a plurality of stored learned models, provide at least one of said data batches to each of said plurality of learned models, obtain the resulting output of each said learned model, and calculate a forecasted market price for said financial instrument based on a combined output of said plurality of learned models;
i. Automatically electronically transmitting said forecasted market price to at least one computing device operated by a user.

11. The method of claim 10 wherein said mechanism for receiving historical price data comprises a communications network link to a data vendor server.

12. The method of claim 10 wherein said second processing unit is a computer graphics card.

13. The method of claim 10 wherein said three artificial neural network model types are generated in parallel by the second processing unit.

14. The method of claim 10 wherein said historical price data comprises price action data for the financial instrument for at least 20 consecutive business days.

15. The method of claim 10 wherein said second processor has more than 2000 processor cores operating in parallel.

16. The method of claim 10 wherein said forecasted market price for said financial instrument is calculated based on an average of the predictions of said learned models.

17. The method of claim 10 comprising the further steps of:
a. Providing a subscription server connected to the internet; and
b. Executing program code in the system to electronically transmit said forecasted market prices to said subscription server as they are calculated;
c. Electronically storing forecasted market prices in storage accessible to said server;
d. Providing controlled account access to said server via the internet to computer systems operated by a plurality of subscribers to enable said subscribers to electronically retrieve said forecasted market prices.

18. The method of claim 10 comprising the further steps of:
a. Electronically calculating the recent accuracy of each said learned model in predicting whether the market price of said financial instrument would increase or decrease day-to-day;
b. Selectively omitting from the calculation of said forecasted market price the results of any learned models that have not correctly predicted day-to-day increase or decrease in price for at least a predetermined percentage of recent predictions.
